(19) United States
(12) Patent Application Publication
(10) Pub. No.: US 2018/0115719 A1
(43) Pub. Date: Apr. 26, 2018

(54) METHOD AND SYSTEM FOR MERCHANDISING FURNITURE ON A LIFE-SIZE DISPLAY

(71) Applicant: Everest Media, Inc., Itasca, IL (US)

(72) Inventors: Felix Rehn-Gour Wuang, Itasca, IL (US); Dennis Baumgartner, St. Charles, IL (US)

(73) Assignee: Everest Media, Inc., Itasca, IL (US)

(21) Appl. No.: 15/331,332

(22) Filed: Oct. 21, 2016

(51) Int. Cl. H04N 5/232; G06T 7/60; H04N 7/18; G06Q 30/06

(52) U.S. Cl. CPC H04N 5/23296; G06T 7/602; G06T 2210/04; G06Q 30/0643; H04N 7/183

(57) ABSTRACT

A system and method for visualizing a room having at least one furniture piece. The method involves selecting the at least one furniture piece to display and displaying an image having the selected at least one furniture piece. A width dimension and a height dimension of the at least one furniture piece within the displayed image are substantially equal to a width dimension and a height dimension of the actual selected at least one furniture piece. The image is displayed with a lower edge of the image near a floor of a room in which the image is displayed. A bottom of the at least one furniture piece within the image is also near the lower edge of the image. This way, a customer next to the display can feel as though they are standing next to an actual furniture piece.

### FIELD OF THE DISCLOSURE

The present disclosure relates to the field of merchandising and virtual display of retail products, such as furniture. More particularly, the present disclosure relates to virtual display of retail products in a retail, showroom or tradeshow environment, where the products are displayed actual size.

### BACKGROUND

Consumers have many challenges when purchasing products. Any given purchase will be influenced by a host of factors, including appearance, style, price, value, and quality. Presently, consumers can shop for furniture by visiting furniture showrooms, visiting big-box retailers, or shopping online using the internet. Each option has its drawbacks. Showrooms and retailers allow for a consumer to physically interact with product. In the case of large goods, such as furniture, however, floor space available at retail locations often allows for only a small percentage of the available products to be displayed. This is especially true when considering the huge array of fabrics, colors and patterns that may be available for any one product. Additionally, attempts to visualize multiple physical product together is difficult due to the size and weight of the products. Furniture is often displayed in pre-arranged suites, and attempting to visualize a bed from one suite with a nightstand from another is generally impractical.

Online shopping is able to solve some of the drawbacks of retail shopping. Shopping via the internet is not limited spatially. Therefore the consumer's computer screen can display thousands of options, and often allows for various abilities to apply different colors and patterns to a product. Shopping from a personal computer, however, does not provide the consumer with the same appreciation for size and scale of a product that comes from being able to physically stand next to the product on a retailer's floor.

There remains a need for a new and improved method of merchandising furniture that combines the benefits of retail shopping with the benefits of shopping at home from the consumer's personal computer.

### SUMMARY

Embodiments of the present disclosure include methods of merchandising furniture on a merchandise display screen. The method includes arranging at least one furniture piece upon a surface at a first location, arranging a camera, the camera having a sensor chip, such that the furniture piece is within the field of view of the camera, and arranging the camera such that the sensor chip is positioned at a low angle relative to the at least one furniture piece. A scale, having known dimensions, may be placed adjacent to the at least one furniture piece. The method continues by capturing a first image with the camera, viewing the first image with a grid overlaid thereon, the grid corresponding to the dimensions of the merchandise display screen, and comparing the grid to the scale. If the scale corresponds with the grid, either: save the first image as an image file, or remove the scale, capture a second image, and save the second image as the image file. If the scale does not correspond with the grid, at least one of: move the camera and zoom the camera, capture a third image, and save the third image as the image file. The method continues by displaying the image file on the merchandise display screen at a second location, the merchandise display screen being at least as tall and at least as wide as the at least one furniture piece such that the at least one furniture piece visible within the displayed image file is substantially equivalent to life-size.

Other embodiments of the present disclosure include methods of visualizing a room having at least one furniture piece. The methods include selecting the at least one furniture piece to display, and displaying an image having the selected at least one furniture piece. A width dimension and a height dimension of the at least one furniture piece within the displayed image are substantially equal to a width dimension and a height dimension of the actual selected at least one furniture piece. The image is displayed such that a lower edge of the image substantially corresponds with a floor of a room in which the image is displayed. A bottom of the at least one furniture piece within the image substantially corresponds with the lower edge of the image.

Yet other embodiments include systems having a display for presenting images of furniture. The display is larger than a life-size of the furniture to be presented thereon. The lower edge of the image presented on the display is adjacent to a floor of a physical location in which the display is located. The display is N pixels by M pixels. The system also includes a database of image files for presentation upon the display. The image files are created using a camera located at a low angle relative to a support surface on which actual furniture pieces were sitting when the image files were created. The image files are created and specifically intended for presentation using N pixels by M pixels.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

FIG. 1 shows the result of following merchandising methods according to embodiments of the present disclosure.

FIG. 2 illustrates an initial set up for creating image files according to embodiments of the present disclosure.

FIG. 3 illustrates a verification step according to an embodiment of the present disclosure.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

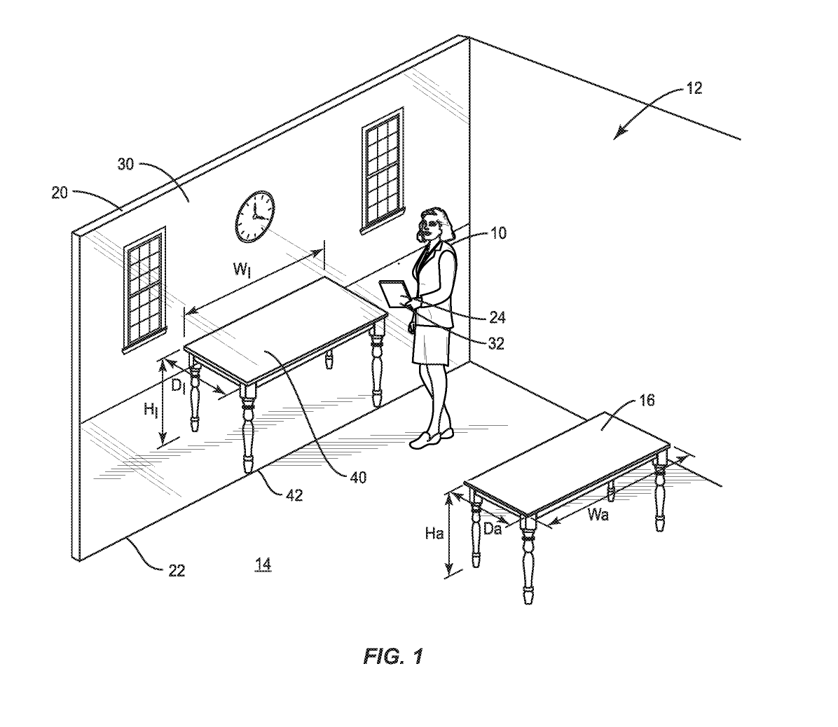

To combine the benefits of retail shopping with the benefits of shopping at home, an improved retail experience is shown in FIG. 1. As seen in FIG. 1, a consumer 10 is present at a physical location, such as a retail location 12, having a floor 14. The retail location 12 includes but is not limited to permanent furniture showrooms, big-box retailers, and permanent or temporary convention or tradeshow showrooms. The floor 14 of the retail location 12 may optionally support one or more actual furniture pieces 16 available for purchase or advance orders. The retail location 12 also includes a life-size display screen 20. The life-size display screen 20 is at least as tall and at least as wide as the actual furniture pieces 16. For example, the life-size display screen 20 may be at least eight feet wide and at least four feet tall. Preferably, the life-size display screen 20 is large enough to represent the size of a wall in a residential room, such as sixteen feet wide and nine feet tall. In one embodiment, a lower edge 22 of the display screen 20 is substantially positioned at floor level. Substantially at floor level means less than six inches from the floor 14 and preferably less than one inch from the floor. The lower edge 22 of the display screen 20 is defined as the bottom of the image projecting portion of the display screen, exclusive of any frame or housing for the display.

In the illustrated embodiment, the display screen 20 is operated with the use of a user interface 24. The user interface 24 may be a mobile device such as a tablet computer or smart phone. The user interface 24 may alternatively be provided as part of a fixed control kiosk (not shown). The user interface 24 may be configured to produce the necessary signals and instructions for the display screen 20 to display a selected image file 30. The image file 30 may be retrieved from memory or a database 32 operably connected to the display screen 20. The database 32 may be stored in association with the user interface 24, on a server at the retail location 12 or at a remote location (not shown) in networked connection with the display screen 20. The user interface 24 allows for selecting the at least one furniture piece 16 to be visualized upon the display screen 20 by selecting the appropriate image file 30.

FIG. 1 shows the display screen 20 with a representative image file 30 displayed thereon. The image file 30 includes a product image 40, i.e. the image of the product itself. The product image 40 represents a product available for purchase, such as the actual furniture piece 16. The image file 30 is specifically created such that the product image 40 will appear substantially life-size when presented on the display screen 20.

As shown in FIG. 1, the actual furniture piece 16 has a width Wₐ and a height Hₐ. The product image 40, which in this example corresponds to the actual furniture product, as presented on the display screen 20, has a width W_{I} and a height H_{I}. The product image 40 is substantially life-size if W_{I}=Wₐ+/−20% and H_{I}=Hₐ+/−20%. Preferably, the product image 40 is substantially life-size if W_{I}=Wₐ+/−5% and H_{I}=Hₐ+/−5%.

In addition to properly sizing the product image 40, visualization for the consumer 10 is further improved by a preferred positioning of the product image 40 on the display screen 20. For example, if the consumer 10 were to stand on the floor 14 immediately adjacent to the display screen 20, the product image 40 can be positioned on the display screen to give the consumer 10 the impression they are standing next to a real furniture piece. This impression allows the consumer to appreciate the height of a table or the seating height of a chair in close relation to the consumer's body size. This preferred positioning includes a bottom 42 of the product image 40 being positioned substantially along the lower edge 22 of the display screen. Substantially along the lower edge 22 can mean having the bottom 42 within six inches of the lower edge, and preferably within 2 inches or less of the lower edge.

Another quality of the product image 40 that impacts the quality of visualization upon the display screen 20 is the perspective of the product image. In other words, the product image 40 displayed on the display screen 20 should have an apparent depth D_{I} similar to the actual depth Dₐ of the actual furniture piece 16. Where the product image 40 is generated by an image capture device, i.e. a camera, the apparent depth D_{I} can be influenced by several factors as discussed below.

Each image file 30 may comprise a plurality of product images 40. In some embodiments, an image file 30 may be generated on-demand by assembling a plurality of separate product images 40. This approach allows the consumer 10 to mix and match the furniture pieces that are visible together as a group on the display screen 20. For example, the user interface 24 may provide a series of menus to select various items from various categories to be displayed simultaneously by the display screen 20. Examples of visualization according to this mix and match embodiment are described in U.S. Published Patent Application 2016/0063600 filed by the present applicant.

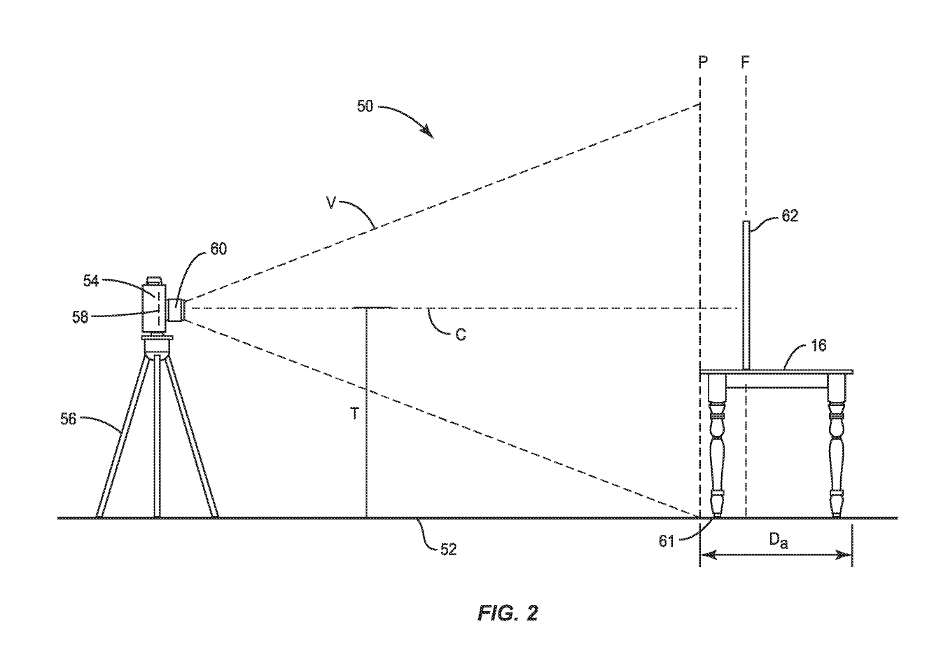

Turning now to FIG. 2, a set 50, according to one embodiment, for creating the image files 30 such that the product images 40 appear life-size on the display screen 20 is now further described. First, one or more actual furniture pieces 16 is arranged on the set 50. The set 50 has a support surface 52, such as the floor. A camera 54, such as a digital single-lens reflex camera (DSLR), may be used. The camera 54 may have a tripod 56 to support the camera 54 above the support surface 52. The camera 54 has a sensor chip 58 with a pixel size X by Y. The camera 54 is preferably positioned square to the one or more furniture pieces 16. In other words, the camera 54 is preferably positioned to shoot the at least one furniture piece 16 straight on, with the central axis C of the camera's field of view V normal to an imaginary plane P on which a front edge of the furniture piece 16 resides. Sometime this is also referred to as having the furniture piece 16 parallel to the chip plane.

To achieve an apparent depth D_{I} close to the actual Dₐ, the camera 54 should be set at a low angle relative to the furniture piece 16. For example, the camera 54 may be mounted with its central axis C positioned a height T above the support surface 52, where T is about fifty-two inches or less, preferably about forty-two to forty-five inches to photograph a sitting height dining set or living room furniture, etc. The height T may be higher to photograph taller furniture pieces, such as a bar set.

Another factor for controlling the apparent depth D_{I} is the focal length of the camera 54. Preferably, the camera 54 will include a telephoto lens 60 with a focal length between about fifty millimeters and about seventy millimeters. Having a longer focal length is possible, but the distance between the camera 54 and the furniture piece 16 becomes quite large to achieve an accurate apparent depth D_{I}. For example, using a fifty millimeter lens 60, the preferred distance from the furniture piece is about twenty-four feet. Using a lens 60 with a focal length significantly less than fifty millimeters will negatively affect the apparent depth D_{I}.

Providing a product image 40 that has a life-size height and a life-size width is dependent upon the display screen 20. The displayed size of the product image 40 depends upon the size of the display screen 20, in pixels, and the resolution of the image file 30. In the illustrated example of FIG. 1, the display screen 20 is suggested to be sixteen feet wide by nine feet tall. The size of the display screen 20 in pixels is N×M, for example 6501×3657.

The camera 54 should be set to capture an image of the furniture piece 16 with a size, in pixels, that is equal to or less than the size of the display screen 20, but no larger than the size, in pixels, of the sensor chip 58. An example image taken by the camera 54 may have a size of 4134 pixels by 2326 pixels or 75% of the size of the display screen 20, with an image processing resolution of 350.

As shown in FIG. 2, a scale 62 of known dimension may be placed within the camera's field of view V. For example, a yard stick, which is three feet in length, is added to the field of view V in the illustrated embodiment. The scale 62 also could be a figurine or household object of known dimensions. In some embodiments, the scale 62 may be omitted if the furniture piece 16 has a known dimension. Use of a scale 62, however, allows for controlling the plane of focus F at which the product image 40 will be displayed at actual size. In other words, due to perspective, the product image 40 will be substantially perfectly life-size at only one plane of focus F. If the furniture piece 16 has significant depth, the product image 40 may be optimized by having the plane of focus F offset from the front plane P. The scale 62 is positioned at the plane of focus F. In one embodiment, the plane of focus F is offset from the front plane P by a distance of one-fourth of the actual depth Dₐ of the one or more furniture pieces 16, in a direction away from the camera 54. If there are multiple furniture pieces 16 in the field of view V, Dₐ would equal the maximum depth of the merchandise relative to the front plane P. Offsetting the plane of focus F away from the camera 54 will result in the front edge of the furniture piece 16 appearing slightly larger than perfectly life-size, but will hold the portion of the furniture piece(s) 16 behind the plane of focus F more proportionate to the life-size width and height.

Another characteristic to consider is the location of the product image 40 when provided on the display screen 20. As described above, the bottom 42 of the product image 40 may correspond with the lower edge 22 of the display screen 20. If there are a plurality of furniture pieces 16 the bottom of piece that resides on the front plane P would correspond to the lower edge 22 of the display screen 20. To accomplish this, the field of view V of the camera 54 should be arranged such that the lower boundary 61 of the field of view V falls just below intersection between the support surface 52 and the bottom of the furniture piece 16.

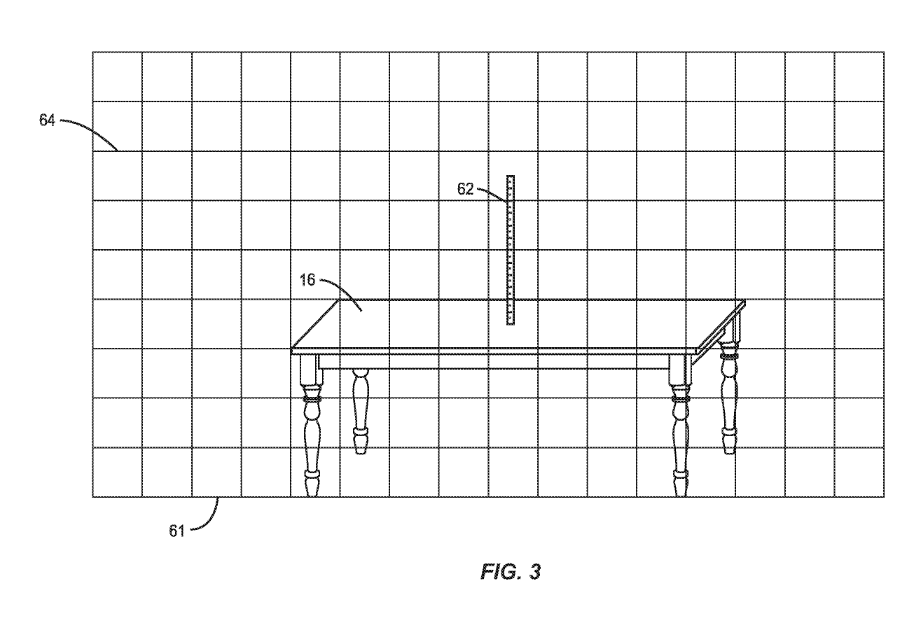

Having described, and shown in FIG. 2, the arrangement of the set 50, the field of view V, and an initial position of the camera 54, a first image capture is taken. The first image capture may be a still image or may be a video or continuously changing image of the camera's field of view V. As seen in FIG. 3, the first image capture or the preview image is then reviewed using a photograph editing software package, such as Capture One by Phase One. The grid tool of the software is used to overlay a grid 64 onto the first image capture equal to the size, in feet/inches, of the display screen. For example, where the sixteen by nine foot display screen 20 is anticipated, the grid 64 would include fifteen equally spaced vertical lines and eight equally spaced horizontal lines. If the scale 62 is correctly sized relative to the grid 64, e.g. a yard stick is equal to three of the boxes created by the grid tool, the set 50 is ready for generating the image file 30. The scale 62 is removed from the field of view V, a second capture is taken without further adjustments to the camera 54 or the furniture piece 16, and the second image capture is stored as the image file 30.

If instead, the scale 62 does not correspond with the grid 64 in the first capture, the zoom of the camera 54 or the position of the camera is adjusted. If the camera is providing a continuous preview image, the preview image is monitored until the scale 62 corresponds correctly with the grid 64. Alternatively, another capture is taken after adjusting either the zoom of the camera 54 or the distance between the camera and the furniture piece 16. For example, if the scale 62 appeared too long, the operator would pull the camera 54 away from the furniture piece 16 or zoom out. If the scale 62 appeared too short, the operator would push in the camera 54 toward the furniture piece 16 or zoom in the camera. Once the image captured, or previewed, by the camera 54 is properly proportioned relative to the grid 64 and the scale 62, the operator removes the scale, captures a final still image and stores the still image as the image file 30.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

1. A method of merchandising furniture on a merchandise display screen, comprising:
arranging at least one furniture piece upon a surface at a first location;
arranging a camera, the camera having a sensor chip, such that the furniture piece is within the field of view of the camera;
arranging the camera such that the sensor chip is positioned at a low angle relative to the at least one furniture piece;
placing a scale having known dimensions adjacent to the at least one furniture piece;
capturing a first image with the camera;
viewing the first image with a grid overlaid thereon, the grid corresponding to the dimensions of the merchandise display screen;
comparing the grid to the scale;
if the scale does correspond with the grid, either:
save the first image as an image file, or
remove the scale, capture a second image, and save the second image as the image file; if the scale does not correspond with the grid:
at least one of: move the camera and zoom the camera,
capture a third image,
save the third image as the image file; and
displaying the image file on the merchandise display screen at a second location, the merchandise display screen being at least as tall and at least as wide as the at least one furniture piece such that the at least one furniture piece visible within the displayed image file is substantially equivalent to life-size.

2. The method of claim 1, wherein the scale is removed before capturing the third image.

3. The method of claim 1, wherein capturing the first image comprises capturing the first image through a lens with a focal length of between about 50 mm and about 70 mm.

4. The method of claim 1, wherein the at least one furniture piece has an actual depth (Dₐ), and placing the scale adjacent to the at least one furniture piece comprises positioning the scale a distance of approximately Dₐ/4 from a front edge of the at least one furniture piece.

5. The method of claim 1, wherein the first image comprises a first resolution, the first resolution being less than a resolution of the merchandise display screen.

6. The method of claim 1, wherein the camera is arranged about 52 inches or less above the surface.

7. The method of claim 1, wherein the camera is arranged square to the at least one furniture piece.

8. The method of claim 1, wherein capturing the first image comprises framing the first image such that a bottom of the at least one furniture piece substantially corresponds with a lower edge of the first image.

9. A method of visualizing a room having at least one furniture piece, comprising:
selecting the at least one furniture piece to display; and
displaying an image having the selected at least one furniture piece,
wherein a width dimension and a height dimension of the at least one furniture piece within the displayed image are substantially equal to a width dimension and a height dimension of the selected at least one furniture piece,
wherein the image is displayed such that a lower edge of the image substantially corresponds with a floor of a room in which the image is displayed, and
wherein a bottom of the at least one furniture piece within the image substantially corresponds with the lower edge of the image.

10. The method of claim 9, further comprising generating an image file usable to display the image.

11. The method of claim 10, wherein generating the image file comprises:
arranging at least one furniture piece upon a surface;
arranging a camera, the camera having a sensor chip, such that the furniture piece is within the field of view of the camera;
arranging the camera such that the sensor chip is positioned at a low angle relative to the at least one furniture piece;
placing a scale adjacent to the at least one furniture piece;
capturing a first image with the camera;
viewing the first image with a grid overlaid thereon, the grid corresponding to the dimensions of the merchandising display;
comparing the grid to the scale;
if the scale does correspond with the grid, either:
save the first image as an image file, or
remove the scale, capture a second image, and save the second image as the image file; and
if the scale does not correspond with the grid:
at least one of: move the camera and zoom the camera,
capture a third image,
save the third image as the image file.

12. The method of claim 11, wherein capturing the first image comprises capturing the first image through a lens with a focal length of between about 50 mm and about 70 mm.

13. The method of claim 11, wherein the at least one furniture piece has an actual depth (Dₐ), and placing the scale adjacent to the at least one furniture piece comprises positioning the scale a distance of approximately Dₐ/4 from a front edge of the at least one furniture piece.

14. The method of claim 11, wherein the first image comprises a first resolution, the first resolution being less than a resolution of a merchandising display.

15. The method of claim 11, wherein capturing the first image comprises framing the first image such that a bottom of the at least one furniture piece substantially corresponds with a lower edge of the first image.

16. The method of claim 11, wherein the camera is arranged about 52 inches or less above the surface.

17. The method of claim 11, wherein the camera is arranged square to the at least one furniture piece.

18. A system comprising:
a display for presenting images of furniture, the display being larger than a life-size of the furniture to be presented thereon, the lower edge of the image presented on the display being adjacent to a floor of a physical location in which the display is located, the display having a size of N pixels by M pixels; and
a database of image files for presentation upon the display, the image files created using a camera located at a low angle relative to a support surface on which actual furniture pieces were sitting when the image files were created, the image files specifically intended for presentation using N pixels by M pixels.

19. The system of claim 18, wherein the camera was less than about 52 inches above the support surface on which actual furniture pieces were sitting when the image files were created.

20. The system of claim 18, further comprising a user interface for accessing the database and selecting one of the image files.
